(19) United States
(12) Patent Application Publication
(10) Pub. No.: US 2017/0346891 A1
(43) Pub. Date: Nov. 30, 2017

(54) COMMUNICATION METHOD

(71) Applicant: NEC Corporation, Tokyo (JP)

(72) Inventors: Masato YASUDA, Tokyo (JP); Kazuaki NAKAJIMA, Tokyo (JP); Hidenori TSUKAHARA, Tokyo (JP)

(73) Assignee: NEC Corporation, Tokyo (JP)

(21) Appl. No.: 15/536,274

(22) PCT Filed: Nov. 9, 2015
(86) PCT No.: PCT/JP2015/005579

§ 371 Date: Jun. 15, 2017

(30) Foreign Application Priority Data
Dec. 15, 2014 (JP) 2014-253113

(51) Int. Cl. H04L 29/08; H04W 76/02; H04W 84/18; H04W 4/08; H04W 92/18

(52) U.S. Cl. CPC H04L 67/1068; H04W 84/18; H04W 4/08; H04W 76/02; H04W 92/18

(57) ABSTRACT

In the present invention, a wireless communication network includes a plurality of nodes which can form P2P (peer-to-peer) groups and are capable of performing wireless communications using a first communication method and wireless communications using a second communication method. A first owner node (GO node) that operates as a first P2P group access point transmits a message for requesting delivery node connection preparations to a second GO node that operates as a second P2P group access point present in a neighborhood by wireless communication using the second communication method, and selects, as a delivery node, one or a plurality of client nodes belonging to the first P2P group. The delivery node is disconnected from the first P2P group and is connected to the second P2P group, and information is transferred between the delivery node and the second GO node.

### TECHNICAL FIELD

The present invention relates to a wireless terminal (P2P terminal) that is mutually wireless-connectable by Peer-to-Peer (hereinafter, referred to as “P2P”), a communication control method therefor, a communication method, and a communication system.

### BACKGROUND ART

Over recent years, from the viewpoint of band widening, security enhancement, and the like, attention has been focused on Wi-Fi Direct as an inter-terminal communication method. A previous Wi-Fi network has been operated in an infrastructure mode in which a specific device is used as an access point (AP). On the other hand, a network conforming to Wi-Fi Direct allows any P2P terminal to become a Group Owner instead of a specific device, and thereby makes it possible to communicate in a group thereof (see, for example, NPL 1). The Group Owner is a P2P terminal operating as an access point of a group, and is capable of forming, as a parent of the group, a group including another P2P terminal as a child (client).

In the P2P group formed in this manner, it is possible to share data among terminals without connecting to the Internet or the like, and to transfer data at high speed. In particular, in Wi-Fi Direct, a robust security protocol is supported and therefore higher security can be achieved compared to the security in a conventional ad hoc mode (IBSS: Independent Basic Service Set or the like).

### CITATION LIST

### Non Patent Literature

NPL 1: Wi-Fi Alliance Technical Committee PSP Task Group, Wi-Fi Peer-to-Peer (P2P) Technical Specification Version 1.1

### SUMMARY OF INVENTION

### Technical Problem

However, in the above-described wireless P2P network, each group is independently formed and operated, and therefore data sharing is limited within the group. Further, in general, a maximum number of terminals of one group has a physical upper limit. When, for example, above-described Wi-Fi Direct is built using an inexpensive wireless LAN device, the number of units of the group is limited to an upper limit of approximately 5 to 10 units supported by the device. Such limitation to a group size limits sharing of messages to only terminals in one group and inhibits information sharing in a larger network including a plurality of groups. In the above-described wireless P2P network, it is difficult to report disaster information, traffic information, and SOS signals with emergency, or voice signals and the like beyond a local group.

An object of the present invention is to provide a communication method, a communication system, a wireless terminal, a communication control method therefor, and a program that solve the above-described problem, i.e., a problem in which information transmission between groups is difficult in a wireless P2P network.

### Solution to Problem

A communication method according to one example embodiment of the present invention is
a communication method in a wireless communication network including a plurality of nodes each capable of performing wireless communication using a first communication method that can form a Peer-to-Peer group and wireless communication using a second communication method, the method including that:
a first owner node that operates as an access point of a first Peer-to-Peer group transmits a message for requesting delivery node connection preparations to a second owner node that operates as an access point of a second Peer-to-Peer group present in a neighborhood by wireless communication using the second communication method and selects, as a delivery node, one or a plurality of client nodes belonging to the first Peer-to-Peer group;
the delivery node is disconnected from the first Peer-to-Peer group and is connected to the second Peer-to-Peer group; and
information is transferred between the delivery node and the second owner node.

A communication system according to another example embodiment of the present invention is
a communication system in a wireless communication network including a plurality of nodes each capable of performing wireless communication using a first communication method that can form a Peer-to-Peer group and wireless communication using a second communication method, the system including:
a first Peer-to-Peer group including a first owner node that operates as an access point and a client node; and
a second Peer-to-Peer group including a second owner node that operates as an access point and a client node, wherein
the first owner node transmits a message for requesting delivery node connection preparations to the second owner node present in a neighborhood by wireless communication using the second communication method and selecting, as a delivery node, one or a plurality of client nodes belonging to the first Peer-to-Peer group,
the delivery node is disconnected from the first Peer-to-Peer group and is connected to the second Peer-to-Peer group, and
information is transferred between the delivery node and the second owner node.

A wireless terminal according to another example embodiment of the present invention is
a wireless terminal including:
a first wireless communication unit using a first communication method that can form a Peer-to-Peer group with another wireless terminal;
a second wireless communication unit using a second communication method; and
an automatic connection control unit,
wherein the automatic connection control unit includes
a function of transmitting, upon an operation as an access point of a first Peer-to-Peer group, a message for requesting delivery node connection preparations to a second owner node that operates as an access point of a second Peer-to-Peer group present in a neighborhood using the second wireless communication unit, a function of selecting, as a delivery node, one or a plurality of client nodes belonging to the first Peer-to-Peer group, and a function of instructing the selected delivery node to be connected to the second Peer-to-Peer group using the first wireless communication unit to cause the delivery node to be disconnected from the first Peer-to-Peer group.

A wireless terminal according to another example embodiment of the present invention is
a wireless terminal including:
a first wireless communication unit using a first communication method that can form a Peer-to-Peer group with another wireless terminal;
a second wireless communication unit using a second communication method; and
an automatic connection control unit, wherein
the automatic connection control unit includes a function of receiving, upon an operation as an access point of a second Peer-to-Peer group, a message for requesting delivery node connection preparations from a first owner node that operates as an access point of a first Peer-to-Peer group present in a neighborhood using the second wireless communication unit and a function of executing, upon receipt of the message, delivery node connection preparation processing using the first wireless communication unit before a delivery node disconnected from the first Peer-to-Peer group is connected.

A communication control method of a wireless terminal according to another example embodiment of the present invention is
a communication control method of a wireless terminal including a first wireless communication unit using a first communication method that can form a Peer-to-Peer group with another wireless terminal and a second wireless communication unit using a second communication method, the communication control method including:
transmitting, upon an operation as an access point of a first Peer-to-Peer group, a message for requesting delivery node connection preparations to a second owner node that operates as an access point of a second Peer-to-Peer group present in a neighborhood using the second wireless communication unit; selecting, as a delivery node, one or a plurality of client nodes belonging to the first Peer-to-Peer group; and
instructing the selected delivery node to be connected to the second Peer-to-Peer group using the first wireless communication unit to cause the delivery node to be disconnected from the first Peer-to-Peer group.

A communication control method of a wireless terminal according to another example embodiment of the present invention is
a communication control method of a wireless terminal including a first wireless communication unit using a first communication method that can form a Peer-to-Peer group with another wireless terminal and a second wireless communication unit using a second communication method, the communication control method including:
receiving, upon an operation as an access point of a second Peer-to-Peer group, a message for requesting delivery node connection preparations from a first owner node that operates as an access point of a first Peer-to-Peer group present in a neighborhood using the second wireless communication unit; and executing delivery node connection preparation processing using the first wireless communication unit before a delivery node disconnected from the first Peer-to-Peer group is connected.

A program according to another example embodiment of the present invention causes
a computer to function as:
a first wireless communication unit using a first communication method that can form a Peer-to-Peer group with another wireless terminal;
a second wireless communication unit using a second communication method; and
an automatic connection control unit including a function of transmitting, upon an operation as an access point of a first Peer-to-Peer group, a message for requesting delivery node connection preparations to a second owner node that operates as an access point of a second Peer-to-Peer group present in a neighborhood using the second wireless communication unit, a function of selecting, as a delivery node, one or a plurality of client nodes belonging to the first Peer-to-Peer group, and a function of instructing the selected delivery node to be connected to the second Peer-to-Peer group using the first wireless communication unit to cause the delivery node to be disconnected from the first Peer-to-Peer group.

A program according to another example embodiment of the present invention causes
a computer to function as:
a first wireless communication unit using a first communication method that can form a Peer-to-Peer group with another wireless terminal;
a second wireless communication unit using a second communication method; and
an automatic connection control unit including a function of receiving, upon an operation as an access point of a second Peer-to-Peer group, a message for requesting delivery node connection preparations from a first owner node that operates as an access point of a first Peer-to-Peer group present in a neighborhood using the second wireless communication unit and a function of executing, upon receipt of the message, delivery node connection preparation processing using the first wireless communication unit before a delivery node disconnected from the first Peer-to-Peer group is connected.

### Advantageous Effects of Invention

The present invention includes the above-described configuration and therefore is capable of transmitting information between a first and a second Peer-to-Peer group via a delivery node.

Further, a second owner node can receive a predetermined message before a delivery node is connected. Therefore, for example, it is possible to make preparations for delivery node connection in such a way as to previously disconnecting an existing client to enable connection with a delivery node, when the number of the member of a second Peer-to-Peer group reaches an upper limit.

### BRIEF DESCRIPTION OF DRAWINGS

FIG. 1 is a block diagram of a communication system according to a first example embodiment of the present invention.

FIG. 2 is a flowchart illustrating an operation of the communication system according to the first example embodiment of the present invention.

FIG. 3 is a block diagram of a node (wireless terminal) configuring the communication system according to the first example embodiment of the present invention.

FIG. 4 is a diagram illustrating one example of a connection node list stored on a node configuring the communication system according to the first example embodiment of the present invention.

FIG. 5 is a diagram illustrating one example of group information stored on a node configuring the communication system according to the first example embodiment of the present invention.

FIG. 6 is a diagram illustrating a connection flow of Wi-Fi Direct used in automatic connection by the communication system according to the first example embodiment of the present invention.

FIG. 7 is a diagram illustrating an operation flow of DEVICE DISCOVERY used in discovery of device by the communication system according to the first example embodiment of the present invention.

FIG. 8 is a diagram illustrating an operation flow of DEVICE DISCOVERY used in discovery of an existing group by the communication system according to the first example embodiment of the present invention.

FIG. 9 is a diagram illustrating an operation flow of GO NEGOTIATION used in automatic connection by the communication system according to the first example embodiment of the present invention.

FIG. 10 is a diagram illustrating an operation flow of PROVISION DISCOVERY used in automatic connection by the communication system according to the first example embodiment of the present invention.

FIG. 11 is a diagram illustrating an operation flow of INVITATION used in automatic connection by the communication system according to the first example embodiment of the present invention.

FIG. 12 is a diagram illustrating an operation flow of disconnection of a node used in automatic connection by the communication system according to the first example embodiment of the present invention.

FIG. 13 is a diagram illustrating an operation flow of a node (wireless terminal) configuring the communication system according to the first example embodiment of the present invention.

FIG. 14 is a block diagram illustrating a node (wireless terminal) configuring a communication system according to a second example embodiment of the present invention.

FIG. 15 is a diagram illustrating one example of node information stored on a node configuring the communication system according to the second example embodiment of the present invention.

FIG. 16 is a block diagram of the communication system according to the second example embodiment of the present invention.

FIG. 17 is an operation flow of a node (wireless terminal) configuring a communication system according to a third example embodiment of the present invention.

### DESCRIPTION OF EMBODIMENTS

Next, example embodiments of the present invention will be described in detail with reference to the drawings.

### First Example Embodiment

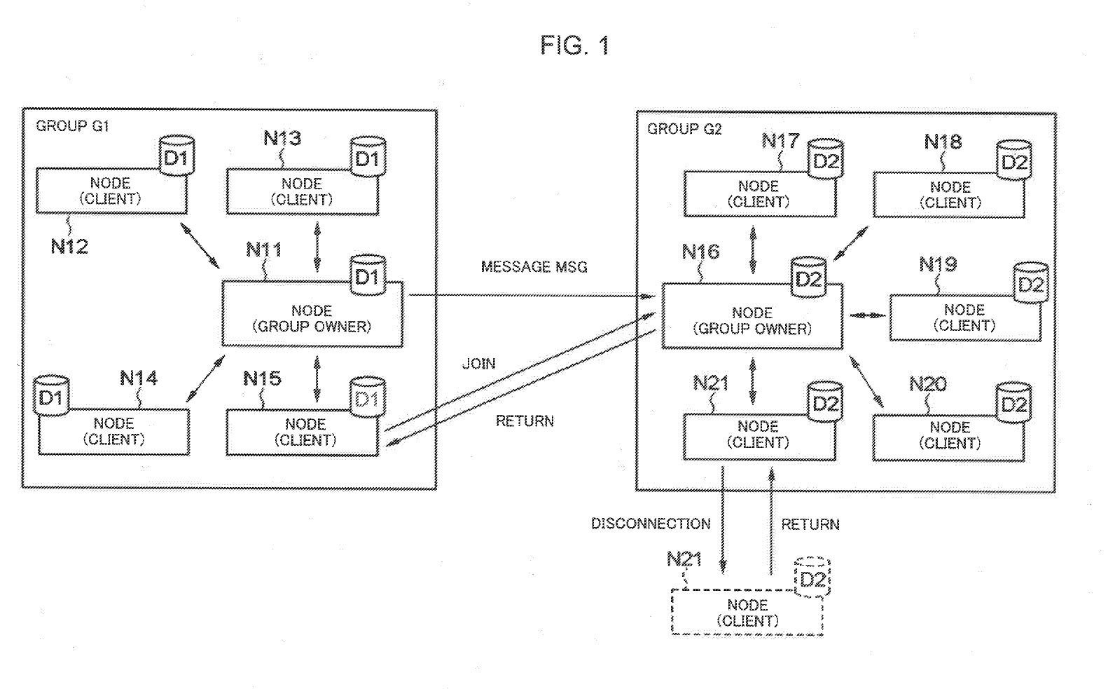

Referring to FIG. 1, a communication system according to a first example embodiment of the present invention is configured by a plurality of nodes N11 to N21. Each of the nodes N11 to N21 can perform wireless communication using a first communication method that can form a Peer-to-Peer group and wireless communication using a second communication method different therefrom. The first communication method is Wi-Fi Direct, for example, and the second communication method is cellular communication such as 3G and LTE, for example. Note that the first communication method is not limited to Wi-Fi Direct when being a communication method capable of forming a Peer-to-Peer group with another wireless terminal. Further, the second communication method is not limited to cellular communication when being a wireless communication method different from the first communication method.

In FIG. 1, a plurality of nodes N11 to N21 configure two Peer-to-Peer groups G1 and G2 (hereinafter, simply referred to as group(s)) by the first communication method. The group G1 is formed with the node N11 as a parent (group owner), and the nodes N12 to N15 are children (clients) thereof. Further, the group G2 is formed with the node N16 as a group owner, and the nodes N17 to N21 are clients thereof. Still further, data D1 and data D2 are shared in the group G1 and the group G2, respectively.

Here, a maximum number of client nodes connectable to one group owner (hereinafter, referred to as a GO) is assumed to be five for description convenience. Under such limitation, five client nodes N17 to N21 are already connected to the GO node N16 of the group G2, and therefore it is difficult for the GO node N16 to have a new node other than these to be connected thereto.

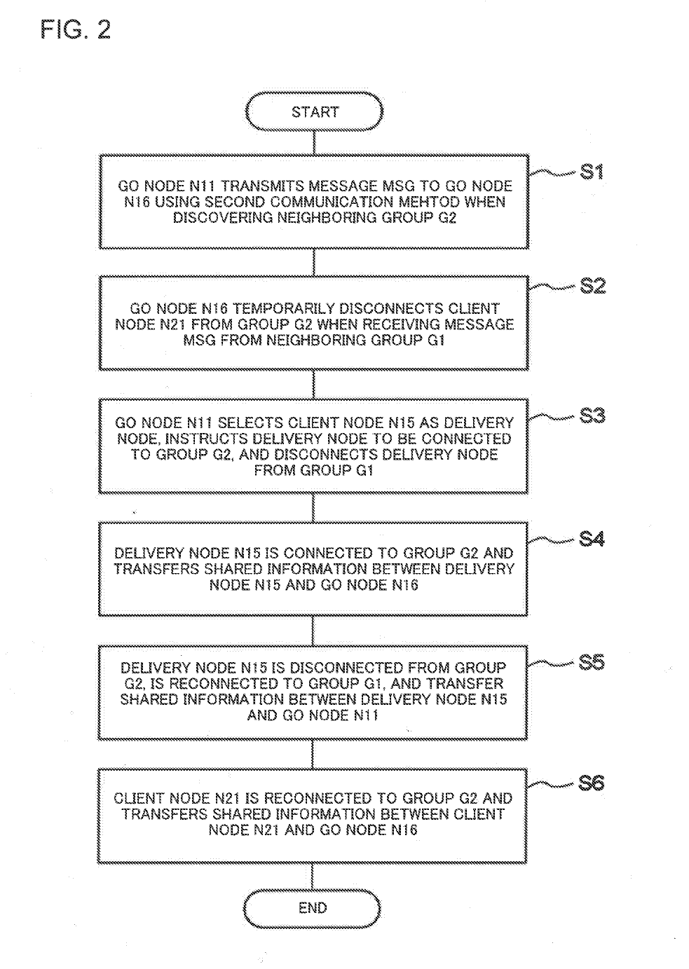

FIG. 2 is a flowchart illustrating an operation of the communication system according to the present example embodiment. With reference to FIG. 2, the following will describe operations for transferring shared information between a group G1 and a group G2 in the communication system according to the present example embodiment.

In a state where groups G1 and G2 are formed, upon discovery of the GO node N16 of a neighboring group G2, the GO node N11 of the group G1 transmits a message MSG for requesting delivery node connection preparations to the GO node N16 using wireless communication by a second communication method (step S1).

Upon receipt of the message MSG from a neighboring group G1, the GO node N16 of the group G2 temporarily disconnects, from the group G2, one or a plurality of client nodes already connected to the group G2 and decreases the number of the connection clients in such a way that a delivery node to be described later can make a new connection (step S2). In the example of FIG. 1, the client node N21 is disconnected from the group G2.

Subsequently, the GO node N11 of the group G1 selects one or a plurality of client nodes as a delivery node, instructs the delivery node to be connected to the group G2, and disconnects the delivery node from the group G1 (step S3). In example of FIG. 1, the client node N15 is selected as a delivery node and is disconnected from the group G1. The delivery node N15 being disconnected from the group G1 is connected to the GO node N16 of the group G2 in accordance with the instruction and transfers information between the delivery node N15 and the GO node N16 (step S4). Specifically, the delivery node N15 transmits data D1 to the GO node N16, and the GO node N16 transmits data D2 to the delivery node N15. Thereby, the GO node N16 of the group G2 can acquire the data D1 being shared in the group G1. In addition, the data D1 is further transferred from the GO node N16 to the client nodes N17 to N20, and thereby the client nodes N17 to N20 can acquire the data D1 being shared in the group G1.

Thereafter, the delivery node N15 is disconnected from the group G2 and is reconnected to the GO node N11 of the group G1, and thereby the delivery node N15 transfers information between the delivery node N15 and the GO node N11 (step S5). Specifically, the delivery node N15 transmits data D2 to the GO node N11. Thereby, the GO node N11 of the group G1 can acquire the data D2 being shared in the group G2. Moreover, the data D2 is further transferred from the GO node N11 to the client nodes N12 to N14, and thereby the client nodes N12 to N14 can acquire the data D2 being shared in the group G2.

On the other hand, the client node N21 being temporarily disconnected from the group G2 is reconnected to the GO node N16 of the group G2 when the delivery node N15 is disconnected from the group G2 (step S6). Further, the data D1 is transferred from the GO node N16 to the client node N21, and thereby the client node N21 acquires the data D1 being shared in the group G1.

In this manner, shared information can be transmitted between the group G1 and the group G2 via the delivery node N15.

Further, before being connected to the delivery node N15, the GO node N16 of the group G2 can receive a predetermined message MSG from the GO node N11 of the group G1. Therefore, the GO node N16 can make preparations for delivery node connection in such a way as to previously disconnecting one or a plurality of client nodes from the group G2 having the number of the clients reaching an upper limit, to enable connection with the delivery node N15.

Hereinafter, a configuration and operation of the communication system according to the present example embodiment will be described in more detail.

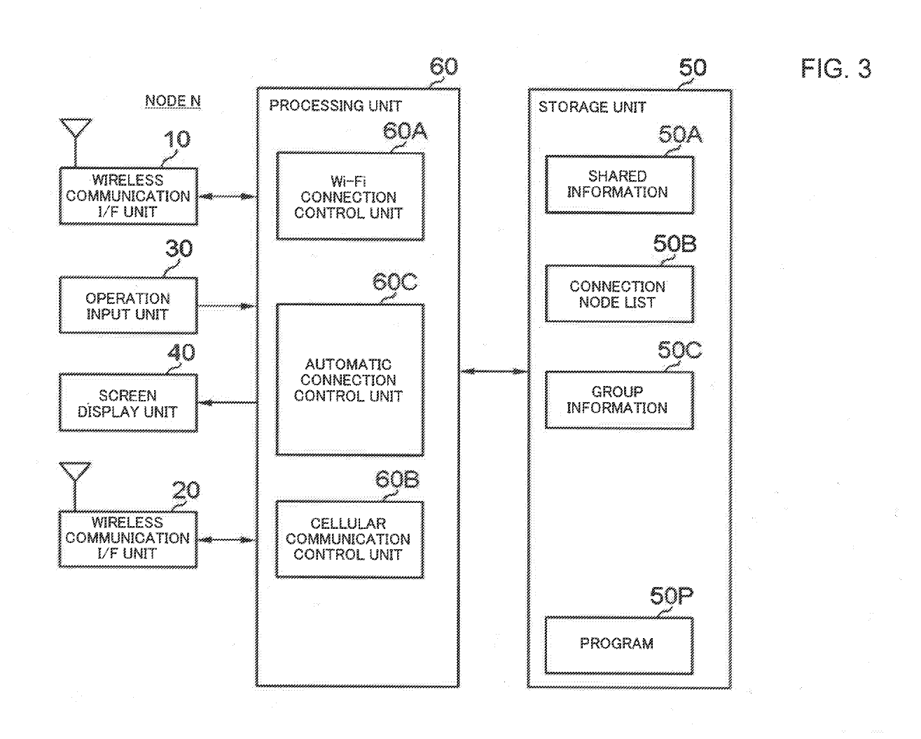

FIG. 3 is a block diagram illustrating a configuration example of a node N used as the nodes N11 to N21. The node N in this example is configured by wireless communication interface units (hereinafter, referred to as wireless communication I/F units) 10 and 20, an operation input unit 30, a screen display unit 40, a storage unit 50, and a processing unit 60.

The wireless communication I/F units 10 and 20, each configured by a dedicated wireless communication circuit, include a function of performing wireless communication with various types of devices such as other wireless terminals connected via a wireless communication line. The wireless communication I/F unit 10 is a wireless LAN interface compatible with Wi-Fi Direct, and the wireless communication I/F unit 20 is a wireless interface compatible with cellular communication such as 3G and LTE.

The operation input unit 30 includes an operation input device such as a keyboard or a mouse, and includes a function of detecting an operation of an operator and outputting the detected operation to the processing unit 60.

The screen display unit 40 includes a screen display device such as an LCD (liquid crystal display) or a PDP (plasma display panel), and includes a function of displaying various types of information such as an operation menu in accordance with an instruction from the processing unit 60.

The storage unit 50 includes a storage device such as a hard disk or a memory, and includes a function of storing processing information and a program 50P necessary for various types of processing in the processing unit 60. The program 50P is a program for making various types of processing units by being read onto the processing unit 60 to be executed. The program 50P is previously read from an external device (not illustrated) or a storage medium (not illustrated) via a data input/output function such as the communication I/F units 10 and 20, or the operation input unit 30, and stored on the storage unit 50. As main processing information stored on the storage unit 50, there are shared information 50A, a connection node list 50B, and group information 50C.

The shared information 50A is data mutually shared with another node and is, for example, disaster information, traffic information, and the like.

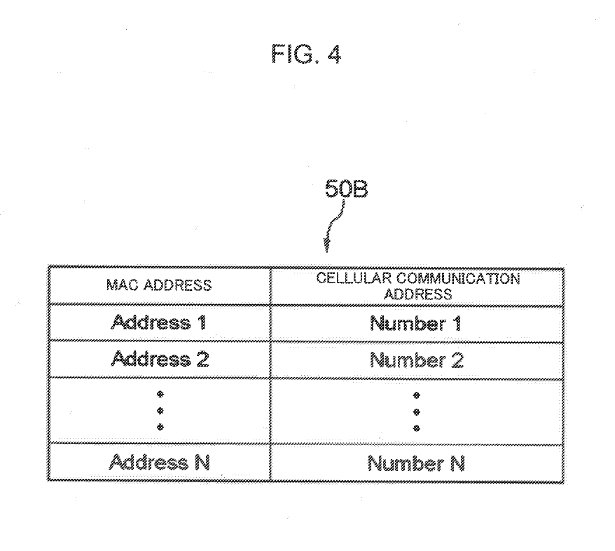

The connection node list 50B is a list of communication addresses of a node permitted for connection. There are two types of communication addresses: one is a communication address of Wi-Fi Direct (e.g., a MAC address); and the other is a communication address of cellular communication (e.g., a phone number or an IP address). FIG. 4 is a configuration example of the connection node list 50B. The connection node list 50B in this example includes a plurality of entries storing a set of an MAC address and a cellular communication address.

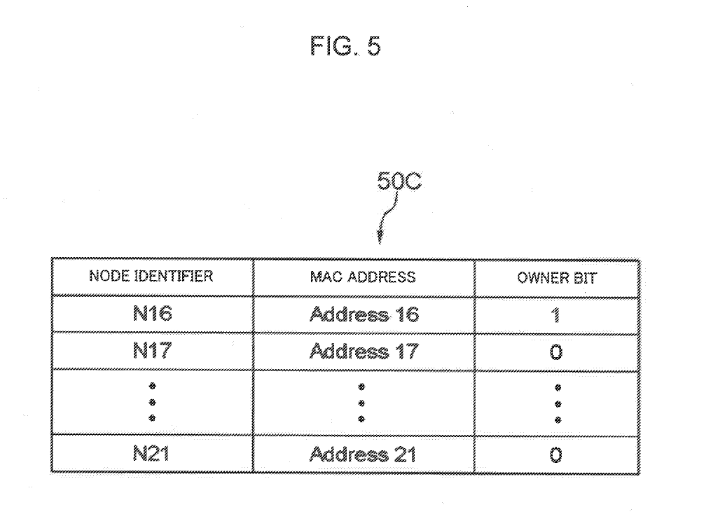

The group information 50C is information relating to a group (P2P group) to which an own terminal belongs. In a case of joining in any group, information for identifying a group owner thereof and information for identifying a client node thereof are registered in the group information 50C. Further, in a case of not joining in any group, the fact of not joining in any group is registered. The node N manages whether the node N is a group owner or a client by the group information 50C and executes processing in accordance with the group owner or processing in accordance with the client. FIG. 5 is a configuration example of the group information 50C. The group information 50C in this example includes entries storing a set of a node identifier, a MAC address, and an owner bit for a number equal to the number of members of the group. The owner bit is set as a value 1 when a node identified by a node identifier or a MAC address of a set thereof is a group owner, and otherwise, i.e., when being a client, the owner bit is set as a value 0.

The processing unit 60 includes a microprocessor such as an MPU, and a peripheral circuit thereof. The processing unit 60 includes a function of reading the program 50P from the storage unit 50 to execute the program, and thereby making various types of processing units by the cooperation of the above hardware and program 50P. Main processing units made by the processing unit 60 include a Wi-Fi connection control unit 60A, a cellular communication control unit 60B, and an automatic connection control unit 60C.

The Wi-Fi connection control unit 60A is a block that generates a packet of Wi-Fi Direct, transmits the generated packet through the wireless communication I/F unit 10, and receives a packet of Wi-Fi Direct also through the wireless communication I/F unit 10. The Wi-Fi connection control unit 60A performs control in units such as “Device Discovery”, “Group Formation”, “WPS (Wi-Fi Protected Setup) Provisioning Phase 1”, and “WPS Provisioning Phase 2”. Further, the Wi-Fi connection control unit 60A receives an event (command) from the automatic connection control unit 60C to start control, and reports the result to the automatic connection control unit 60C as an event (response).

The cellular communication control unit 60B is a block that generates a packet of cellular communication, transmits the generated packet through the wireless communication I/F unit 20, and also receives a packet of cellular communication through the wireless communication I/F unit 20. When receiving an event (command) from the automatic connection control unit 60C, the cellular communication control unit 60B performs control in accordance with the event and reports the result to the automatic connection control unit 60C as an event (response).

The automatic connection control unit 60C is a control unit located in an upper layer of the Wi-Fi connection control unit 60A and the cellular communication control unit 60B. The automatic connection control unit 60C controls the cellular communication control unit 60B and thereby performs transmission/reception of a message across P2P groups of Wi-Fi Direct. Further, the automatic connection control unit 60C controls the Wi-Fi connection control unit 60A and thereby performs automatic connection by Wi-Fi Direct. Specifically, when nodes come close to each other, for example, one group is automatically constructed and inter-node communication is carried out in the group. Further, when a new node comes close to an already-constructed group, the node automatically joins the already-constructed group. Still further, a node is automatically disconnected from the already-constructed group. The automatic connection control unit 60C performs the information sharing method described with reference to FIG. 2 in a Wi-Fi P2P network by such processing for connection and disconnection of Wi-Fi Direct.

Hereinafter, functions of the automatic connection control unit 60C will be described in more detail. First, a function of connection and disconnection of Wi-Fi Direct will be described, and then a control function relating to the information sharing described with reference to FIG. 2 will be described.

### <Connection and Disconnection of Wi-Fi Direct>

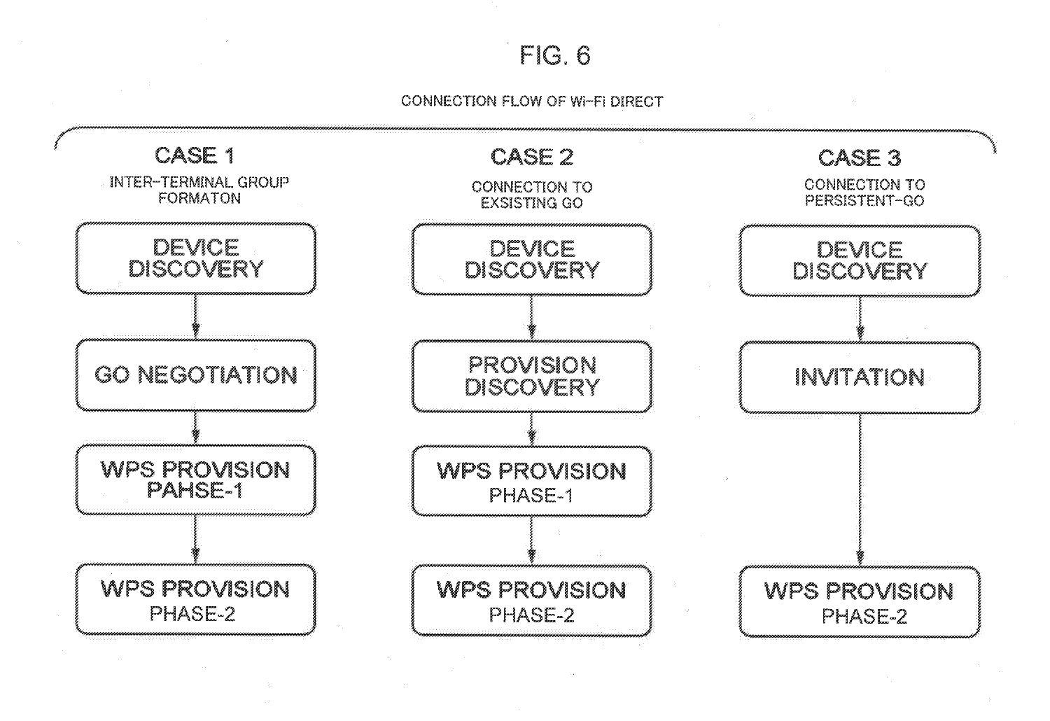

As illustrated in FIG. 6, in a case where a group is formed between nodes (CASE 1), first, neighboring P2P nodes are searched by Device Discovery processing. When the P2P nodes are discovered, the nodes are connected to each other in such a way that any one of the nodes serves as a group owner (GO) by GO Negotiation processing and the other serves as a client. Next, WPS Provision Phase-1 (authentication phase) and Phase-2 (encryption phase) are sequentially executed.

In a case where connection is made to an existing GO (CASE 2), first, a neighboring P2P node is searched by Device Discovery processing. When the discovered P2P node is a GO, connection to the GO is made by Provisional Discovery processing. Next, WPS Provision Phase-1 (authentication phase) and Phase-2 (encryption phase) are sequentially executed.

In a case where connection is made to a Persistent GO (CASE 3), first, a neighboring P2P node is searched by Device Discovery processing. When the discovered P2P node is a Persistent GO, connection to the Persistent GO is made by Invitation processing. Next, WPS Provision Phase-2 (encryption phase) is sequentially executed.

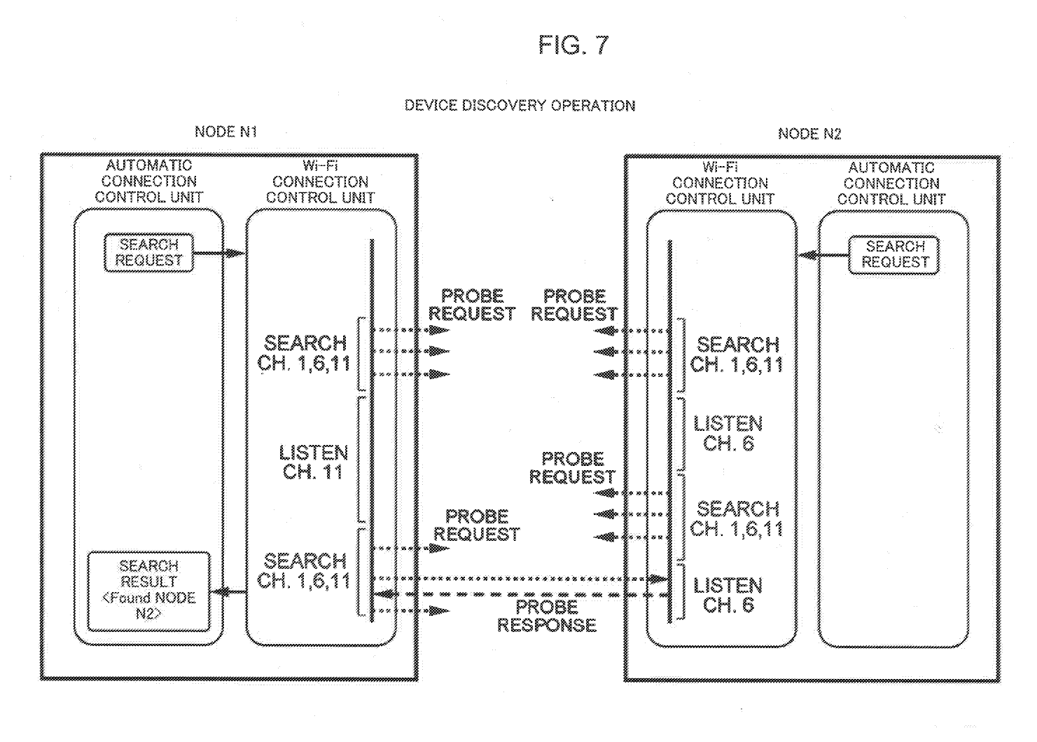

As exemplarily illustrated in FIG. 7, a Device Discovery operation is executed. In other words, when receiving a search request from an automatic connection control unit, a Wi-Fi-connection control unit in each node starts searching an adjacent node and alternately repeats a Search state and a Listen state. In the Search state, the Wi-Fi-connection control unit transmits a Probe Request while sequentially switching a predetermined channel, and waits for a Probe response that is a response to the request. In the Listen state, the Wi-Fi-connection control unit waits for a Probe Request from another node, and when receiving the Prove Request, returns a Probe Response for the received request. When the node N1 is a client of a group, upon receipt of a Probe Response from the node N2, the Wi-Fi connection control unit of the node N1 reports information of the adjacent node N2 to a group owner of the group of the node N1, as adjacent node information.

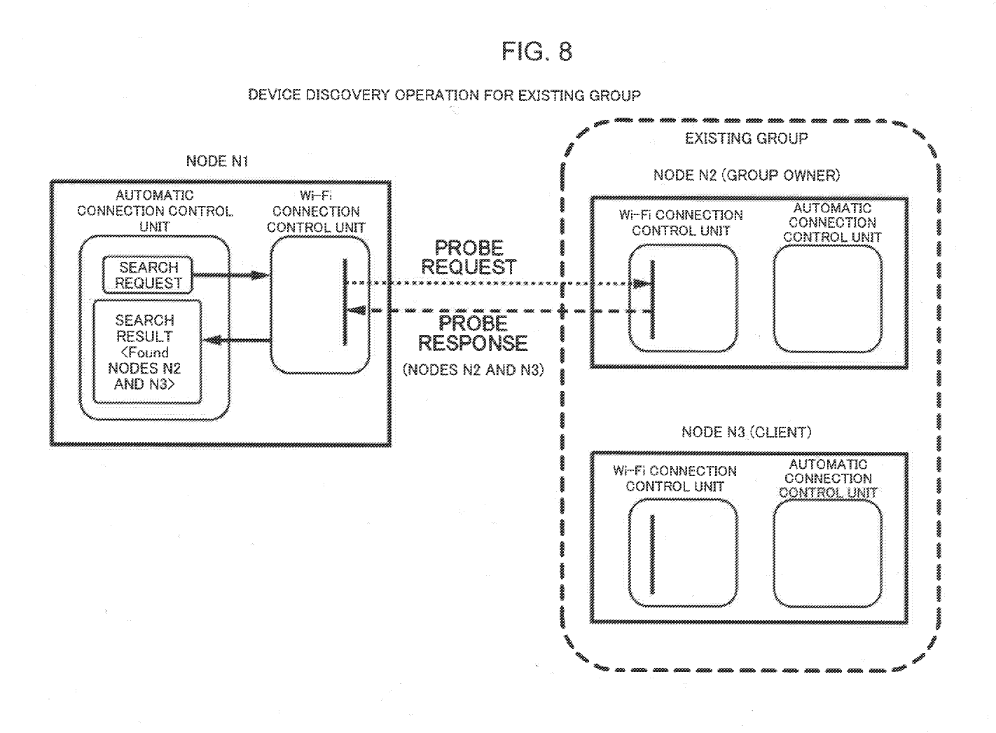

As exemplarily illustrated in FIG. 8, a Device Discovery operation for an existing GO is executed. When a group with the node N2 being a group owner is already constructed, the GO node N2 returns a Probe Response for a Probe Request from the node N1. At that time, a P2P Device Info Attribute of the Probe Response from the GO node N2 includes a list of clients belonging to the group (here, information of the nodes N2 and N3).

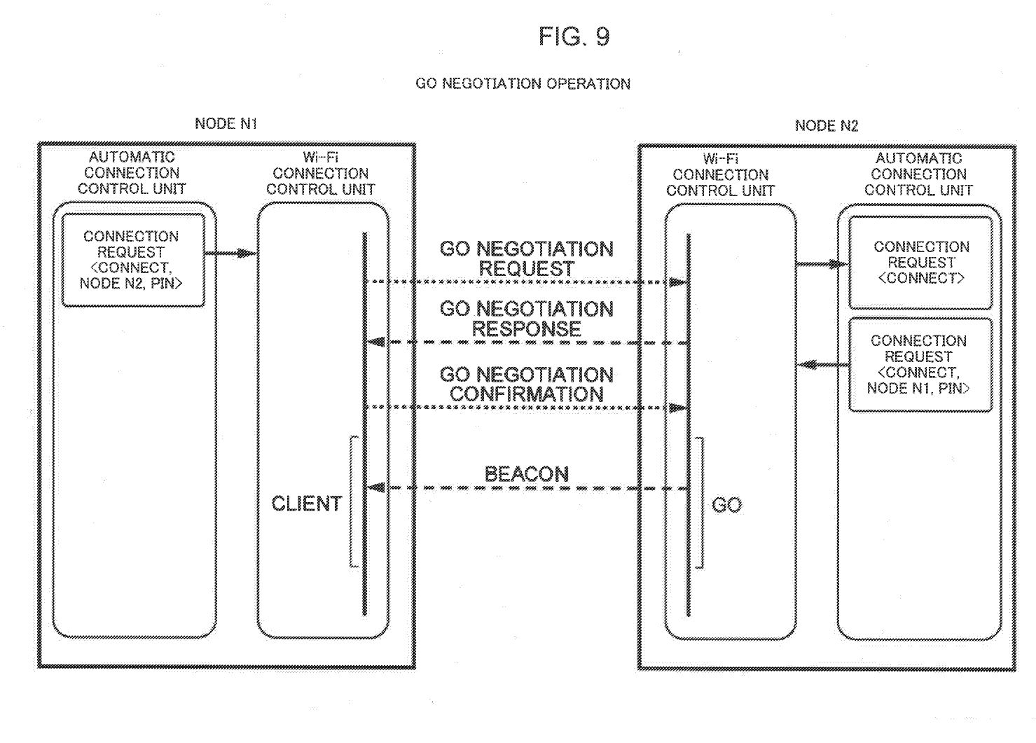

As exemplarily illustrated in FIG. 9, a GO Negotiation operation upon forming a group between terminals is executed. A GO Negotiation Request, a GO negotiation Response, and a GO Negotiation Confirmation are exchanged between nodes, and thereby one node becomes a GO to start broadcasting a beacon.

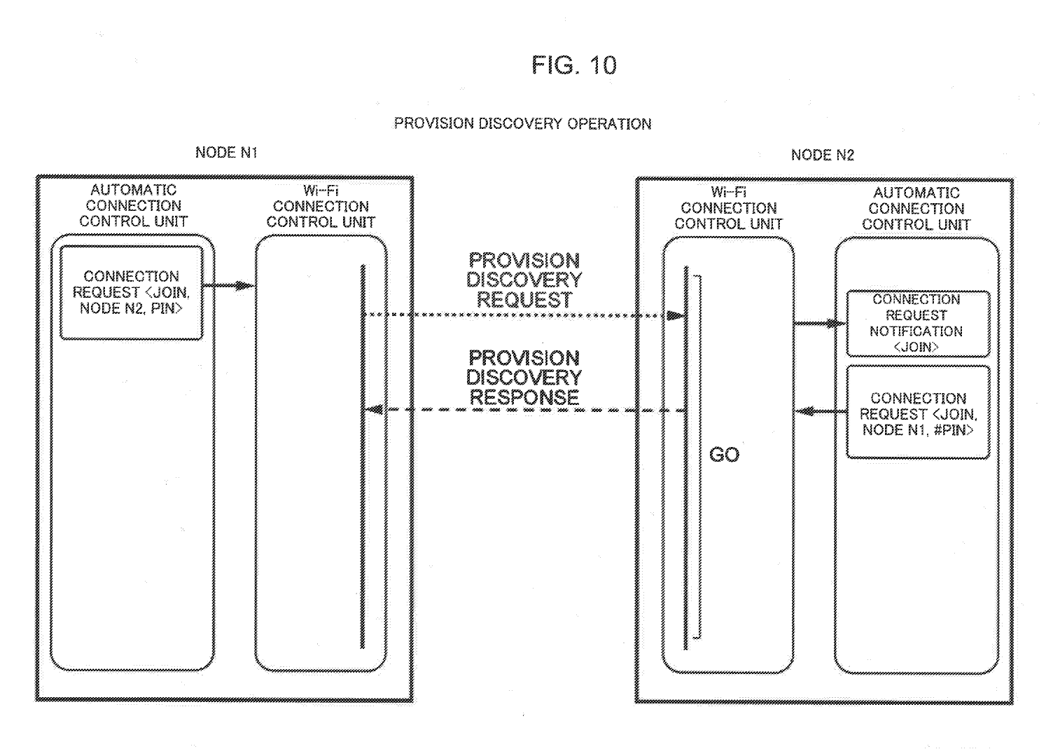

As exemplarily illustrated in FIG. 10, a Provision Discovery operation for connection to an existing GO is executed. For a Provision Discovery Request from the node N1 to the node N2, the GO node N2 returns a Provision Discovery Response to the node N1, and thereby the node N1 is connected to the node N2.

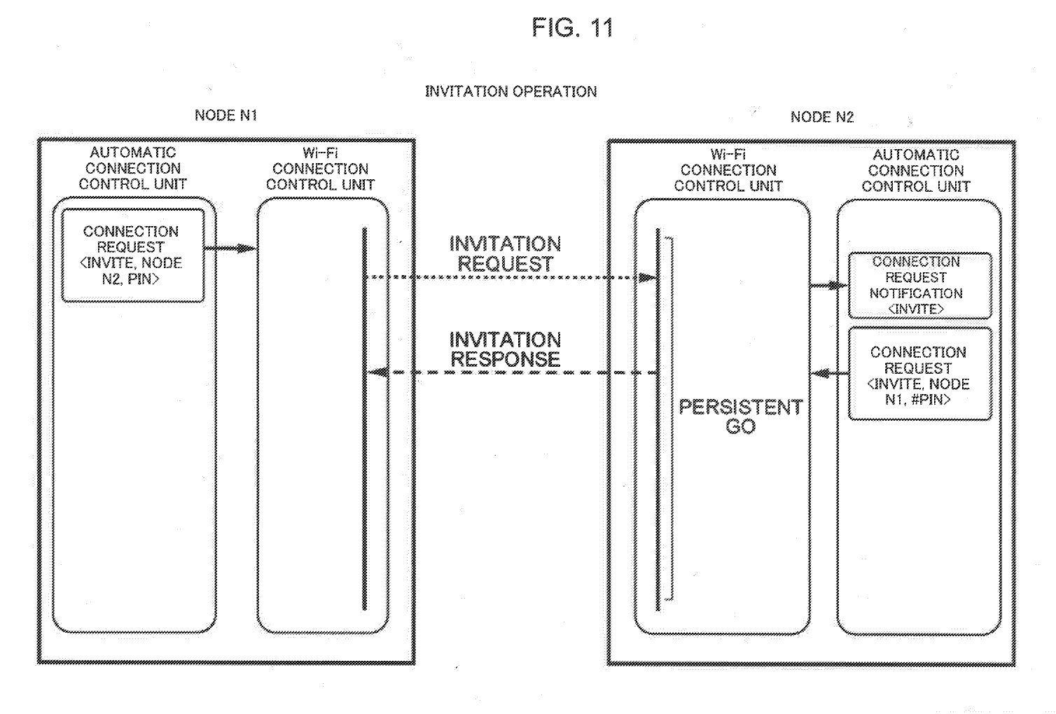

As exemplarily illustrated in FIG. 11, an Invitation operation for connection to a Persistent-GO is executed. For an Invitation Request from the node N1 to the node N2, the Persistent-GO node N2 returns an Invitation Response to the node N1, and thereby the node N1 is connected to the node N2.

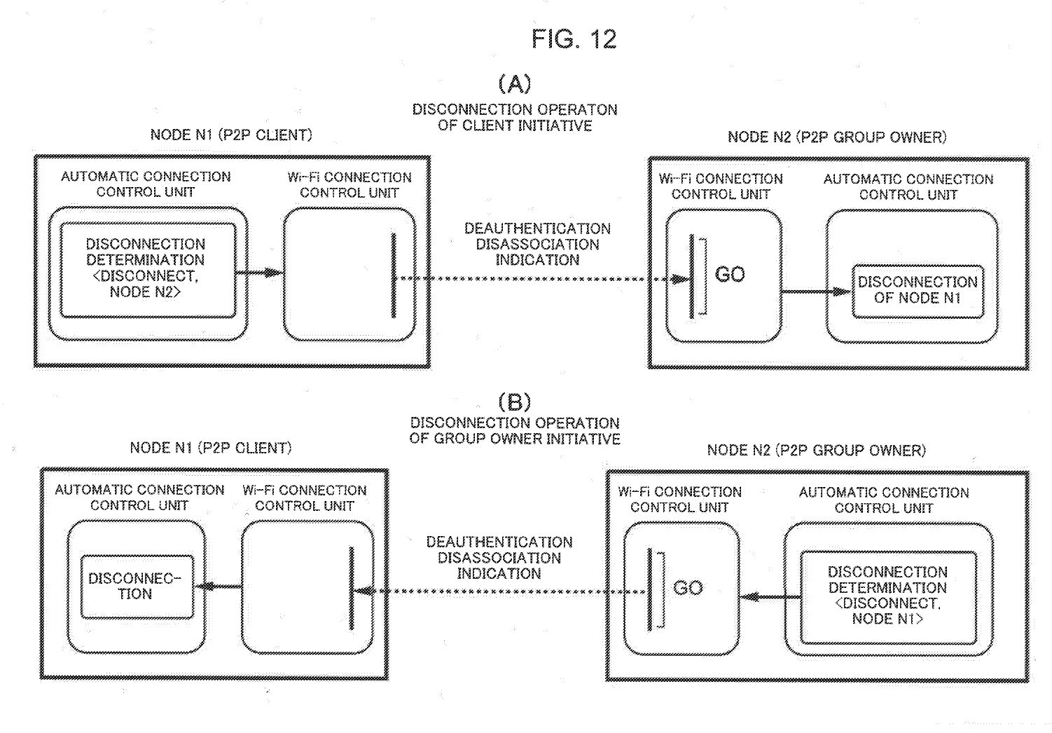

As illustrated in FIG. 12, in a client-initiative disconnection, the client node N1 transmits a Deauthentication or Disassociation Indication to the GO node N2, to enable disconnection. Inversely, in group-owner-initiative disconnection, the GO node N2 transmits a Deauthentication or Disassociation Indication to the client node N1, to enable the client to be disconnected.

### <Control Function Relating to Information Sharing>

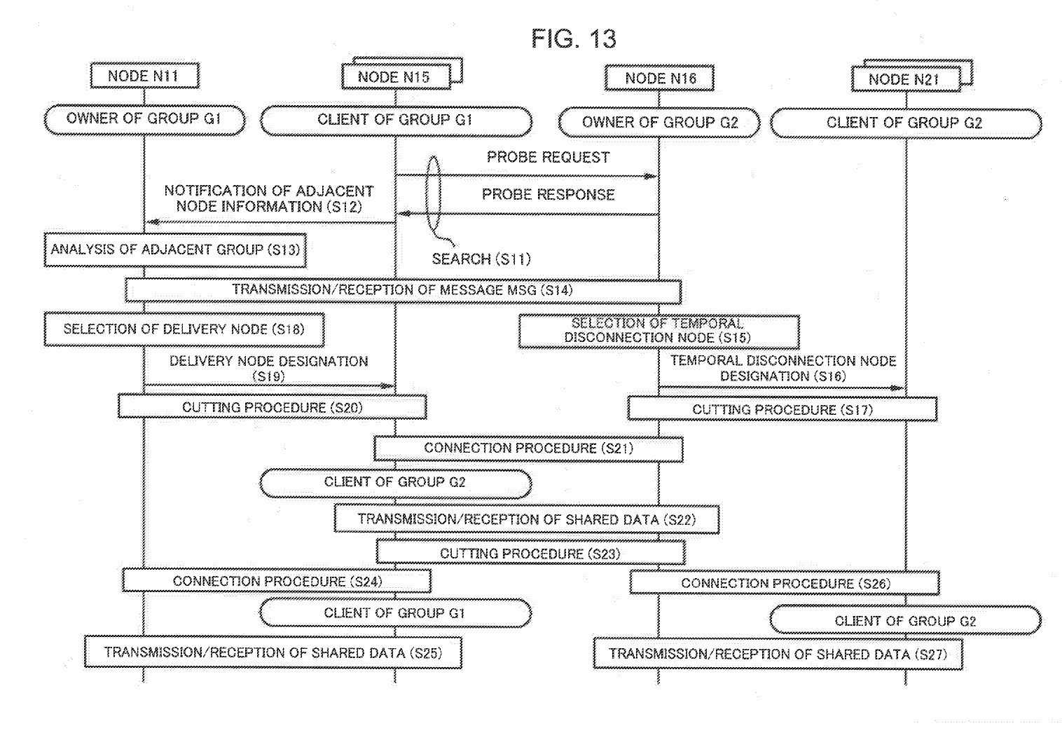

FIG. 13 is a flowchart illustrating an operation of the node N according to the present example embodiment. Hereinafter, with reference to FIG. 13, an operation of the node N upon sharing information between the group G1 and the group G2 will be described.

In a state where the groups G1 and G2 are formed as illustrated in FIG. 1, the automatic connection control units of the GO node N11 and the client nodes N12 to N15 of the group G1 search a neighboring group. This search is performed in conformity with a Device Discovery procedure of the Wi-Fi Direct specification. In FIG. 13, for example, the client nodes N12 to N15 each transmit a probe request for Device Discovery processing, receive a probe response from an adjacent group G2 (S11), and thereby discover the GO node N16 of the group G2. The automatic connection control units of the client nodes N12 to N15 report, to the GO node N11, information of the group G2 discovered by the probe response as adjacent node information (S12). In FIG. 13, the client nodes N12 to N15 of the group G1 search an adjacent group and report information of the discovered group to the GO node N11. However, the GO node N11 may search and discover an adjacent group.

When discovering the GO node N16 of an adjacent group G2, the automatic connection control unit of the GO node N11 of the group G1 analyzes the adjacent group (S13). In this analysis, it is determined whether the adjacent group is a partner for data sharing, and further determined whether the number of the connection clients of the adjacent group reaches an upper limit.

In determining whether the adjacent group is a partner for data sharing, the automatic connection control unit of the GO node N11 makes the determination by researching whether a MAC address included in a probe request or a probe response, transmitted from the GO node N16 of the group G2, and being information for identifying the GO node N16 is matched with any one of MAC addresses listed on the connection node list 50B, for example. When the MAC address of the GO node N16 is written on the connection node list 50B, it is determined that the group G2 formed by the GO node N16 is a partner for data sharing, and otherwise, it is determined that the group G2 is not a partner for data sharing. Although a MAC address is used herein, it is possible to determine whether to be a partner for data sharing by matching information other than the MAC address, as long as using information capable of uniquely identifying a node. When determining that the GO node N16 of the group G2 is not a partner for data sharing, the automatic connection control unit of the GO node N11 does not execute any operations relating to data sharing with the group G2 such as transmission of a predetermined message MSG to be described later and designation/disconnection of a delivery node.

Further, in the determination whether the number of the connection clients of an adjacent group reaches an upper limit, the automatic connection control unit of the GO node N11 determines whether the number of the connection clients of the group G2 reaches an upper limit based on a P2P Group Limit bit value included in a probe request or a probe response transmitted from the GO node N16 of the group G2. When the number of the connection clients of the group G2 reaches the upper limit, the automatic connection control unit of the GO node N11 transmits a predetermined message to be described later. On the other hand, when the number of the connection clients of the group G2 does not reach the upper limit, the automatic connection control unit omits transmission processing for the predetermined message to be described later, and moves to the subsequent processing.

When the adjacent group G2 is a partner for data sharing and furthermore the number of the connection clients of the adjacent group reaches the upper limit, the automatic connection control unit of the GO node N11 of the group G1 transmits a predetermined message to the GO node N16 using wireless communication by the cellular communication control unit (S14). As an address of cellular communication of the GO node N16, there is used a cellular communication address recorded on the connection node list 50B of the storage unit 50 corresponding to the MAC address of the GO node N16. The message MSG may include a command for requesting delivery node connection preparations, specifically, a command for requesting disconnection of one or a plurality of client nodes, in addition to information for identifying the GO node N11 of a transmission source and information for identifying the GO node N16 of a transmission destination. The automatic connection control unit of the GO node N16 of the group G2 receives the above message MSG from the GO node N11 using wireless communication by the cellular communication control unit (S14).

When receiving the message MSG from the adjacent group G1, the automatic connection control unit of the GO node N16 of the group G2 selects one or a plurality of client nodes to be temporarily disconnected from the group G2 as a temporal disconnection node (S15). In FIG. 13, the client node N21 is selected as a temporal disconnection node. Subsequently, the automatic connection control unit of the GO node N11 performs temporal disconnection node designation for the temporal disconnection node N21 (S16). Information (e.g., a MAC address) of the node N16 to be reconnected after disconnection from the group G2, a condition for reconnection to the group G2, and the like are specified in this temporal disconnection node designation. As the condition for reconnection, reconnecting to the GO node N16 when a certain time elapses after disconnection from the group G2 is conceivable. In addition, reconnecting to the GO node N16 when the number of the terminals of the group G2 increases once, for example, to an upper limit of the number of the connection clients and then decreases again after disconnection from the group G2 is also conceivable. Further, the GO node N16 disconnects the temporal disconnection node N21 from the group G2 (S17). At that time, a cutting procedure is executed under control of the automatic connection control unit of the GO node N16 and the automatic connection control unit of the temporal disconnection node N21. In the above example, when receiving a predetermined message MSG from a GO node of another group G1, the GO node N16 disconnects one or a plurality of clients from the group G2 without any condition. However, when it is examined whether the number of the connection clients of the group G2 reaches an upper limit and if the number is smaller than the upper limit of the number of the connection clients by a certain value (e.g., 1) or more, process S15 to S17 for a temporal disconnection node may be omitted.

On the other hand, after transmitting the message MSG, the automatic connection control unit of the GO node N11 of the group G1 selects one or a plurality of delivery nodes (S18). In the delivery node selection, it is preferable to select, as a delivery node, a client that holds all pieces of shared data of the group G1. In FIG. 13, the client node N15 is selected as a delivery node. Subsequently, the automatic connection control unit of the GO node N11 performs delivery node designation for the client node N15 selected as the delivery node (S19). In this delivery node designation, information (e.g., a MAC address) of the node N16 to be connected after disconnection from the group G1, a condition for reconnection to the group G1 and the like are specified. As the condition for reconnection, reconnecting to the GO node N11 after transmission/reception of shared data to/from the node N16 and the like is conceivable. In addition, reconnecting to the GO node N11 when a certain time elapses after disconnection from the group G1 and the like is also conceivable. Further, the GO node N11 disconnects the delivery node N15 from the group G1 (S20). At that time, a cutting procedure is executed under control of the automatic connection control unit of the GO node N11 and the automatic connection control unit of the client node N15.

The delivery node N15 disconnected from the group G1 is connected to the GO node N16 of the group G2 in accordance with the delivery node designation (S21). At that time, a connection procedure is executed under control of the automatic connection control unit of the delivery node N15 and the automatic connection control unit of the GO node N16.

The delivery node N15 having become a client of the group G2 transfers shared information between the delivery node N15 and the GO node N16 (S22). Specifically, the automatic connection control unit of the delivery node N15 transmits the shared information 50A (data D1) on the storage unit to the GO node N16 using the Wi-Fi connection control unit 60A. Accordingly, the automatic connection control unit of the GO node N16 receives the shared information 50A (data D1) from the delivery node N15 using the Wi-Fi connection control unit 60A and stores the received information on the storage unit 50. Inversely, the automatic connection control unit of the GO node N16 transmits the shared information 50A (data D2) on the storage unit to the delivery node N15 using the Wi-Fi connection control unit 60A. Accordingly, the automatic connection control unit of the delivery node N15 receives the shared information 50A (data D2) from the GO node N16 using the Wi-Fi connection control unit 60A and stores the received information on the storage unit 50. Thereafter, although not illustrated in FIG. 13, the data D1 is transferred from the GO node N16 to the client nodes N17 to N20 being connected.

Then, the delivery node N15 is first disconnected from the group G2 when a condition for reconnection to the group G1 is satisfied (S23). At that time, a cutting procedure is executed under control of the automatic connection control unit of the GO node N16 and the automatic connection control unit of the delivery node N15. The delivery node N15 is then reconnected to the GO node N11 of the group G1 (S24). At that time, a connection procedure is executed under control of the automatic connection control unit of the GO node N11 and the automatic connection control unit of the delivery node N15.

The delivery node N15 again having become a client of the group G1 transfers shared information between the delivery node N15 and the GO node N16 (S25). Specifically, the automatic connection control unit of the delivery node N15 transmits the shared information 50A (data D2) on the storage unit to the GO node N11 using the Wi-Fi connection control unit 60A. Accordingly, the automatic connection control unit of the GO node N11 receives the shared information 50A (data D2) from the delivery node N15 using the Wi-Fi connection control unit 60A and stores the received information on the storage unit 50. Thereafter, although not illustrated in FIG. 13, the data D2 is transferred from the GO node N11 to the client nodes N17 to N20 being connected.

On the other hand, when a condition for reconnection to the group G2 is satisfied, the temporal disconnection node N21 is reconnected to the GO node N16 of the group G2 (S26). At that time, a connection procedure is executed under control of the automatic connection control unit of the GO node N16 and the automatic connection control unit of the temporal disconnection node N21. The temporal disconnection node N21 again having become a client of the group G2 transfers shared information between the temporal disconnection node N21 and the GO node N16 (S27). Specifically, the automatic connection control unit of the GO node N16 transmits the shared information 50A (data D1) on the storage unit to the node N21 using the Wi-Fi connection control unit 60A. Accordingly, the automatic connection control unit of the node N21 receives the shared information 50A (data D1) from the GO node N16 using the Wi-Fi connection control unit 60A and stores the received information on the storage unit 50.

In this manner, the present example embodiment transmits shared information between groups.

### Second Example Embodiment

In the first example embodiment, a GO node discovers a GO node of another group present in a neighborhood in conformity with a Device Discovery procedure of the Wi-Fi Direct specification. In contrast, in the present example embodiment, a GO node exchanges position information with another node using cellular communication and compares position information of the GO node and position information of the another node to discover a GO node of another group present in a neighborhood.

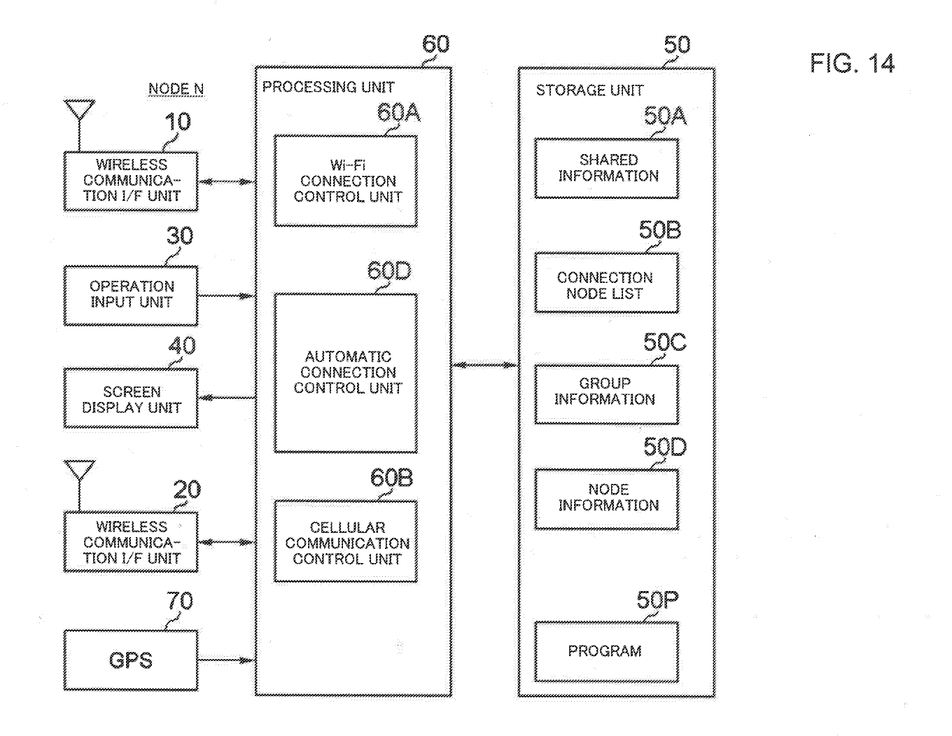

Referring to FIG. 14, in comparison with the node N illustrated in FIG. 3, a node N used in the present example embodiment is different from the node N illustrated in FIG. 3 in points in which: a GPS 70 is included; node information 50D is stored on a storage unit 50; and instead of the automatic connection control unit 60C, an automatic connection control unit 60D is included. Other than these, the node N used in the present example embodiment includes the same components and functions as those of the node N illustrated in FIG. 3.

The GPS 70 includes a function of measuring a latitude x, a longitude y, and a height z indicating a current position of the node N and transmitting the measured values to a processing unit 60.

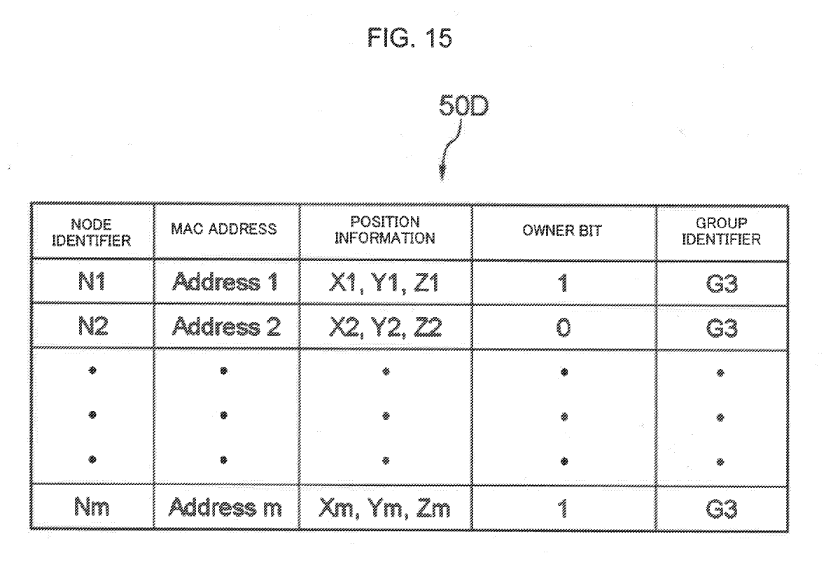

The node information 50D of the storage unit 50 is information in which position information or the like of another node is recorded. FIG. 15 is a configuration example of the node information 50D. The node information 50D of this example includes a plurality of entries that each store a set of a node identifier, a MAC address, position information, an owner bit, and a group identifier. The node identifier is a name, a number, or the like that uniquely identifies a node. The MAC address is a communication address of the node. The position information is a latitude x, a longitude y, and a height z indicating a current position of the node. The owner bit is a bit set as a value 1 when a node identified by a node identifier or a MAC address of a set thereof is a group owner, and set as a value 0 otherwise, i.e., when the node is a client. With respect to the group identifier, when a node identified by a node identifier or a MAC address of a set thereof is being connected to a P2P group, a name or a number that uniquely identifies the group is recorded, and otherwise, a NULL is recorded, for example.

The automatic connection control unit 60D is different from the automatic connection control unit 60C of the node N illustrated in FIG. 3 in a function of discovering a neighboring group. Other than this, the automatic connection control unit 60D includes the same functions as in the automatic connection control unit 60C. Hereinafter, a function of discovering a neighboring group by the automatic connection control unit 60D will be described.

The automatic connection control unit 60D transmits a position-information notification message to another node by cellular communication at a constant cycle using a cellular communication control unit 60B. In the position-information notification message, a current position of the node detected by the GPS 70, a node identifier of the node N, a MAC address, an owner bit, and a group identifier are stored. A destination is all nodes in which cellular communication addresses are recorded on a connection node list 50B, respectively. However, another node connected to the same group as for the node N managed by the group information 60D may be excluded.

Further, the automatic connection control unit 60D receives, using the cellular communication control unit 60B, a position-information notification message transmitted from another node by cellular communication and records the received message in the node information 50D of the storage unit 50. Specifically, when an entry including a node identifier or a MAC address matched with a node identifier or a MAC address in the received position-information notification message does not exist in the node information 50D, the automatic connection control unit 60D stores the received position-information notification message in a new entry and adds the new entry to the node information 50D. When such entry exists, the automatic connection control unit 60D overwrites the existing entry by the received position-information notification message.

Further, every time updating the node information 50D, the automatic connection control unit 60D compares the latest position information of the node N being detected by the GPS 70 with position information of another node in the node information 50D. Accordingly, the automatic connection control unit 60D detects all other nodes in which a distance between both nodes is equal to or smaller than a threshold. The threshold herein may be set, for example, as a maximum value or an average value of a distance where two nodes can execute a connection procedure by Wi-Fi Direct. Subsequently, when there are one or more other nodes being detected, the automatic connection control unit 60D detects a GO node having an owner bit of a value 1 among these other nodes, as a GO node of another group present in a neighborhood.

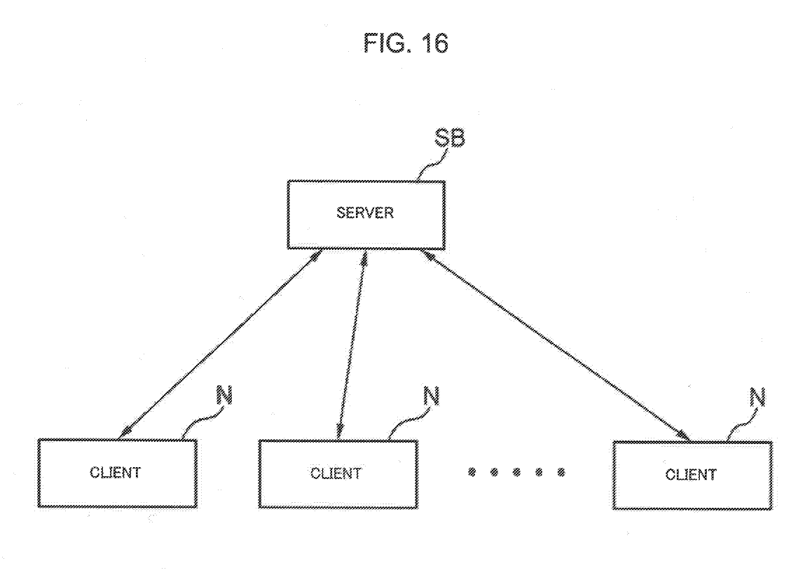

In the above-described operations, the automatic connection control unit 60D directly transmits/receives a position-information notification message to/from another node. However, as illustrated in FIG. 16, for example, a position-information notification message may be transmitted/received among nodes via a server SB. At that time, the automatic connection control unit 60D of each node N transmits a position-information notification message to the server SB by cellular communication at a constant cycle using the cellular communication control unit 60B. The server SB stores node information (hereinafter, referred to as server-side node information) similar to the node information 50D. When an entry including a node identifier or a MAC address matched with a node identifier or a MAC address in the received node-position information notification does not exist in the server-side node information, the server SB stores the received position-information notification message in a new entry, and adds the stored message to the server-side node information. When such entry exists, the server SB overwrites the existing entry by the received position-information notification message. Further, the automatic connection control unit 60D of each node N downloads server-side node information from the server SB by cellular communication at a constant cycle using the cellular communication control unit 60B. The automatic connection control unit 60D then stores the downloaded information on the storage unit 50 as the node information 50D. Every time downloading new server-side node information, the automatic connection control unit 60D compares the latest position information of the node N being detected by the GPS 70 with position information of another node in the node information 50D. Accordingly, the automatic connection control unit 60D detects all other nodes in which a distance between both nodes is equal to or smaller than a threshold. Subsequently, when there are one or more other nodes being detected, the automatic connection control unit 60D detects a GO node having an owner bit of a value 1 among these other nodes, as a GO node of another group present in a neighborhood.

### Third Example Embodiment

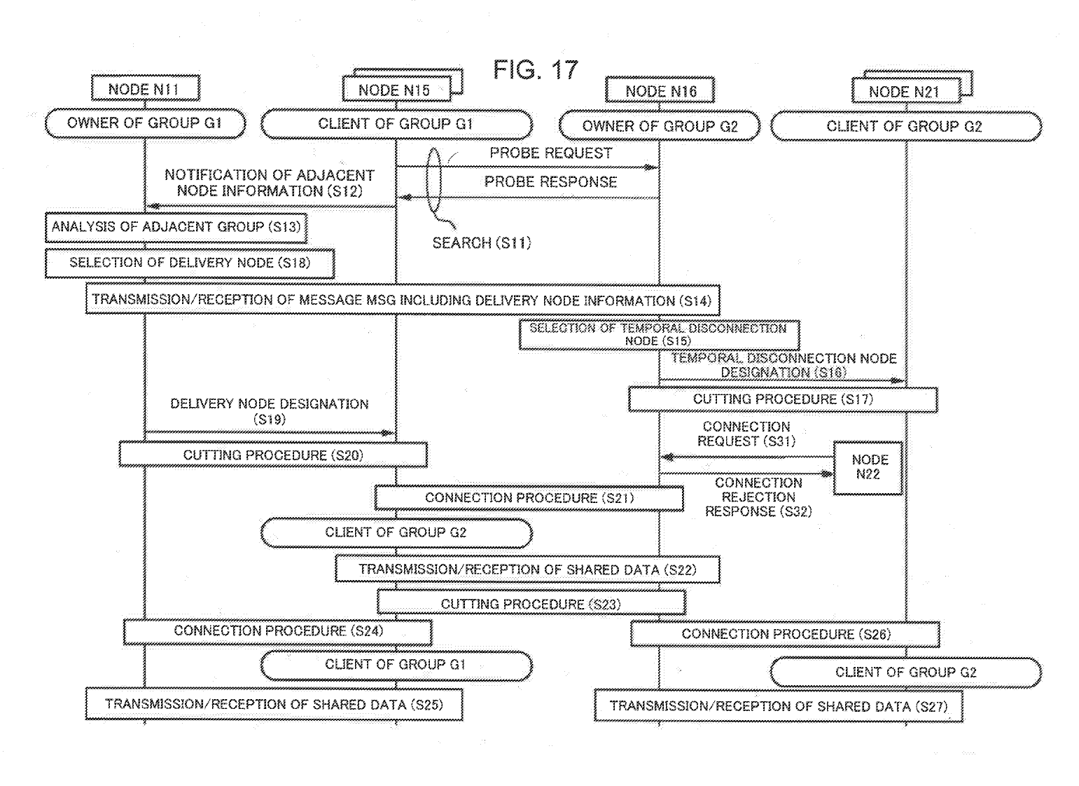

In the first example embodiment, as illustrated in FIG. 13, the GO node N11 of the first group G1 selects a delivery node after transmitting a message MSG to the second group (S14, S18). In contrast, in the present example embodiment, as illustrated in FIG. 17, the automatic connection control unit of the GO node N11 of the first group G1 adds, to a message MSG, delivery node information (e.g., a MAC address) for uniquely identifying the selected delivery node after selecting a delivery node, and transmits the added message MSG to the second group (S18, S14).

The automatic connection control unit of the GO node N16 of the second group G2 having received the message MSG recognizes the delivery node N15 to be connected to the group G2 by being disconnected from the group G1 by the delivery node information in the message MSG. Accordingly, the unit suspends connection of another node to the own-group G2 until connection to the recognized delivery node N15 is completed. In other words, as illustrated in FIG. 17, even when a connection request from the node N22 other than the delivery node N15 to the group G2 is made (S31), the automatic connection control unit of the GO node N16 rejects the connection (S32). Thereby, the number of the connection clients of the group G2 is prevented from reaching an upper limit before connection of the delivery node N15 is made.

While the present invention has been described by citing several example embodiments, the present invention is not limited to the above example embodiments and can be subjected to various other types of additions/modifications.

It should be noted that the present invention is based upon and claims the benefit of priority from Japanese Patent Application No. 2014-253113, filed on Dec. 15, 2014, and the contents described in the patent application are incorporated herein in its entirety by reference.

### INDUSTRIAL APPLICABILITY

The present invention is applicable in a P2P network including a plurality of nodes (wireless terminals) capable of dynamically forming a group.

### REFERENCE SIGNS LIST

G1 to G2 . . . Group
GO . . . Group Owner
N . . . Node
D . . . Data
MSG . . . Message
10, 20 . . . Wireless communication I/F unit
30 . . . Operation input unit
40 . . . Screen display unit
50 . . . Storage unit
50A . . . Shared information
50B . . . Connection node list
50C . . . Group information
50D . . . Node information
60 . . . Processing unit
60A Wi-Fi connection control unit
60B . . . Cellular communication control unit
60C, 60D . . . Automatic connection control unit

1. (canceled)

2. (canceled)

3. A wireless terminal comprising:
a first wireless communication unit configured to perform a first communication method that can form a Peer-to-Peer group with another wireless terminal;
a second wireless communication unit configured to perform a second communication method; and
an automatic connection controller,
wherein the automatic connection controller includes
a function of transmitting, upon an operation as an access point of a first Peer-to-Peer group, a message for requesting delivery node connection preparations to a second owner node that operates as an access point of a second Peer-to-Peer group present in a neighborhood using the second wireless communication unit, a function of selecting, as a delivery node, one or a plurality of client nodes belonging to the first Peer-to-Peer group, and a function of instructing the selected delivery node to be connected to the second Peer-to-Peer group using the first wireless communication unit to cause the delivery node to be disconnected from the first Peer-to-Peer group.

4. The wireless terminal according to claim 3, wherein
the automatic connection controller transmits the message when discovering the second owner node present in a neighborhood.

5. The wireless terminal according to claim 3, wherein
the automatic connection controller discovers the second owner node present in a neighborhood using the first wireless communication unit in conformity with a Device Discovery procedure of the Wi-Fi Direct specification.

6. The wireless terminal according to claim 5, wherein
the automatic connection controller determines whether a number of a connection clients of the second Peer-to-Peer group reaches an upper limit based on a P2P Group Limit bit value included in a probe request or a probe response transmitted from the second owner node and transmits the message only when the number of the connection clients reaches the upper limit.

7. The wireless terminal according to claim 5, wherein
the automatic connection controller determines whether the second owner node is a partner for data sharing based on information for identifying the second owner node included in a probe request or a probe response transmitted from the second owner node, transmits the predetermined message only when the second owner node is a partner for data sharing, selects the delivery node, and disconnects the delivery node from the first Peer-to-Peer group.

8. The wireless terminal according to claim 3, wherein
the automatic connection controller exchanges position information of a wireless terminal mutually with another wireless terminal using the second wireless communication unit, compares position information of the wireless terminal and position information of another wireless terminal, and discovers the second owner node present in a neighborhood.

9. The wireless terminal according to claim 3, wherein
the automatic connection controller reconnects the delivery node disconnected from the second Peer-to-Peer group to the first Peer-to-Peer group using the first wireless communication unit.

10. The wireless terminal according to claim 9, wherein
the automatic connection controller transfers information between the wireless terminal and the reconnected delivery node using the first wireless communication unit.

11. The wireless terminal according to claim 3, wherein
the automatic connection controller transmits the message including the information of the delivery node to the second owner node.

12. A wireless terminal comprising:
a first wireless communication unit using a first communication method that can form a Peer-to-Peer group with another wireless terminal;
a second wireless communication unit using a second communication method; and
an automatic connection controller, wherein
the automatic connection controller includes a function of receiving, upon an operation as an access point of a second Peer-to-Peer group, a message for requesting delivery node connection preparations from a first owner node that operates as an access point of a first Peer-to-Peer group present in a neighborhood using the second wireless communication unit and a function of executing, upon receipt of the message, delivery node connection preparation processing using the first wireless communication unit before a delivery node disconnected from the first Peer-to-Peer group is connected.

13. The wireless terminal according to claim 12, wherein
the automatic connection controller disconnects one or a plurality of client nodes from the second Peer-to-Peer group in the delivery node connection preparation processing.

14. The wireless terminal according to claim 12, wherein
the message includes information of the delivery node, and the automatic connection controller suspends new connection of a node other than the delivery node until connection of a delivery node identified by the information of the delivery node is completed, in the delivery node connection preparation processing.

15. The wireless terminal according to claim 12, wherein
the automatic connection controller reconnects the disconnected client node to the second Peer-to-Peer group using the first wireless communication unit when a specific condition occurs.

16. The wireless terminal according to claim 15, wherein
the specific condition is that a certain time elapses after the client node is disconnected.

17. The wireless terminal according to claim 15, wherein
the specific condition is that a number of terminals of the second Peer-to-Peer group increases once and then decreases again after the client node is disconnected.

18. The wireless terminal according to claim 12, wherein
the automatic connection controller transfers information between the automatic connection controller and the connected delivery node using the first wireless communication unit.

19. A communication control method of a wireless terminal including a first wireless communication unit using a first communication method that can form a Peer-to-Peer group with another wireless terminal and a second wireless communication unit using a second communication method, the communication control method comprising:
transmitting, upon an operation as an access point of a first Peer-to-Peer group, a message for requesting delivery node connection preparations to a second owner node that operates as an access point of a second Peer-to-Peer group present in a neighborhood using the second wireless communication unit; selecting, as a delivery node, one or a plurality of client nodes belonging to the first Peer-to-Peer group; and
instructing the selected delivery node to be connected to the second Peer-to-Peer group using the first wireless communication unit to cause the delivery node to be disconnected from the first Peer-to-Peer group.

20. (canceled)

21. (canceled)

22. (canceled)

23. The wireless terminal according to claim 4, wherein
the automatic connection controller discovers the second owner node present in a neighborhood using the first wireless communication unit in conformity with a Device Discovery procedure of the Wi-Fi Direct specification.

24. The wireless terminal according to claim 6, wherein
the automatic connection controller determines whether the second owner node is a partner for data sharing based on information for identifying the second owner node included in a probe request or a probe response transmitted from the second owner node, transmits the predetermined message only when the second owner node is a partner for data sharing, selects the delivery node, and disconnects the delivery node from the first Peer-to-Peer group.

25. The wireless terminal according to claim 4, wherein
the automatic connection controller exchanges position information of a wireless terminal mutually with another wireless terminal using the second wireless communication unit, compares position information of the wireless terminal and position information of another wireless terminal, and discovers the second owner node present in a neighborhood.
